(19) United States
(12) Patent Application Publication
(10) Pub. No.: US 2025/0196178 A1
(43) Pub. Date: Jun. 19, 2025

(54) Electrode Coating Apparatus

(71) Applicant: SK On Co., Ltd., Seoul (KR)

(72) Inventors: Dae Hee KIM, Daejeon (KR); Ji Yun YANG, Daejeon (KR); Ju Hyun KIM, Daejeon (KR); Jun Eun SONG, Daejeon (KR)

(21) Appl. No.: 18/944,215

(22) Filed: Nov. 12, 2024

(30) Foreign Application Priority Data
Dec. 14, 2023 (KR) 10-2023-0181773

(51) Int. Cl. B05C 11/02; B05C 5/02; B05C 21/00

(52) U.S. Cl. CPC B05C 11/025; B05C 5/0245; B05C 21/00

(57) ABSTRACT

Proposed is an electrode coating apparatus including a coating roller brought into contact with a base substrate and configured to rotate for the base substrate to move, a slot die coater configured to supply slurry on one surface of the base substrate in contact with the coating roller, and a blocking roller, in an upper stream in which the base substrate moves toward the coating roller, located between the coating roller and the base substrate and configured to block air flowing between the coating roller and the base substrate, and the electrode coating apparatus is configured to minimize air flowing between the coating roller and the base substrate to improve the coating uniformity of an electrode active material.

### CROSS REFERENCE TO RELATED APPLICATIONS

This patent document claims the priority and benefits of Korean Patent Application No. 10-2023-0181773, filed Dec. 14, 2023, the entire contents of which are incorporated herein by reference for all purposes.

### TECHNICAL FIELD

The present disclosure relates to an electrode coating apparatus.

### BACKGROUND

Secondary batteries are batteries that can be charged and discharged. A secondary battery may include an electrode, a separator, and an electrolyte. An electrode may be formed by coating an electrode active material to a current collector. In a process of coating a slurry including the electrode active material on the current collector with a thin metal film form, an electrode coating apparatus may be used. The electrode coating apparatus may coat an electrode active material of a slurry form on a surface or both surfaces of the current collector. The current collector coated with the electrode active material is transferred to a dryer to dry a solvent of the slurry.

### SUMMARY

The present disclosure provides an electrode coating apparatus configured to prevent air inflow between a roller and a base substrate.

According to an aspect of the present disclosure, the electrode coating apparatus may be applied to produce of batteries that can be widely used in green technology such as electric vehicles, battery charging stations, solar energy generation and wind energy generation using batteries, etc.

According to an aspect of the present disclosure, the electrode coating apparatus may be applied to produce batteries used in eco-friendly electric vehicles, hybrid vehicles, etc. that can suppress air pollution and greenhouse gas emissions to prevent climate change.

According to the present disclosure, there is provided an electrode coating apparatus including: a coating roller brought into contact with a base substrate and configured to rotate for the base substrate to be moved; a slot die coater configured to supply slurry on one surface of the base substrate in contact with the coating roller; and a blocking roller, in an upper stream in which the base substrate is moved toward the coating roller, located between the coating roller and the base substrate and configured to block air flowing between the coating roller and the base substrate.

According to an embodiment, the blocking roller may have a diameter smaller than a diameter of a transfer roller transferring the base substrate.

According to an embodiment, the blocking roller may have a diameter ranging from 40 mm to 120 mm.

According to an embodiment, the blocking roller may include a brush formed on an external circumferential surface.

According to an embodiment, the electrode coating apparatus may further include: a position driver configured to adjust a location of the blocking roller with respect to the coating roller.

According to an embodiment, the position driver may be configured to locate the blocking roller to a position where a wedge-shaped space among the coating roller, the blocking roller, and the base substrate is minimized, without the blocking roller in contact with the coating roller.

According to an embodiment, the electrode coating apparatus may further include: a blocking plate configured to block air from flowing through a wedge-shaped space formed among the blocking roller, the coating roller, and the base substrate.

According to an embodiment, the blocking plate may be formed in a wedged shape, and a first portion of the wedged shape may be formed into a curved line corresponding to a curved surface of the coating roller, and a second portion thereof may be formed into a curved line corresponding to a curved surface of the blocking roller.

According to an embodiment, the electrode coating apparatus may further include: a position driver configured to adjust a position of the blocking roller with respect to the coating roller and to adjust a position of the blocking plate so that the blocking plate may block a wedge-shaped space.

The features and advantages of the present disclosure will be more apparent from the following detained description based on the accompanying drawings.

Further, it should be noted that the terms and words used in the specification and the claims should not be construed as being limited to ordinary meanings or dictionary definitions, and should be interpreted as having a meaning and a concept that are consistent with the technical idea of the present disclosure based on the principle that an inventor may appropriately define the concept of a term to best describe the present disclosure of the inventor.

According to the embodiment of the present disclosure, it is possible to minimize air flowing between the coating roller and the base substrate to improve the coating uniformity of an electrode active material.

According to the embodiment of the present disclosure, even in an environment in which the rotation speed of the coating roller is fast, it is possible to minimize air flowing between the coating roller and the base substrate.

According to the embodiment of the present disclosure, it is possible to minimize air flowing between the coating roller and the base substrate to prevent defects causing wrinkles in an electrode.

### BRIEF DESCRIPTION OF THE DRAWINGS

FIG. 1 is a view illustrating an electrode coating apparatus according to an embodiment.

FIG. 2 is a view illustrating an airflow in the electrode coating apparatus according to an embodiment.

FIG. 3 is a view illustrating a blocking roller on which a brush is formed according to an embodiment.

FIG. 4 is a view illustrating the electrode coating apparatus including a blocking plate according to an embodiment.

FIG. 5 is a view illustrating an airflow in the electrode coating apparatus including the blocking plate according to an embodiment.

### DETAILED DESCRIPTION

Hereinbelow, (referring to accompanying drawings) the present disclosure will be described in detail. However, the description is merely exemplary and the present disclosure is not limited to the specific embodiment which will be described as exemplary.

Hereinbelow, an embodiment of the present disclosure will be described in detail with reference to the accompanying drawings.

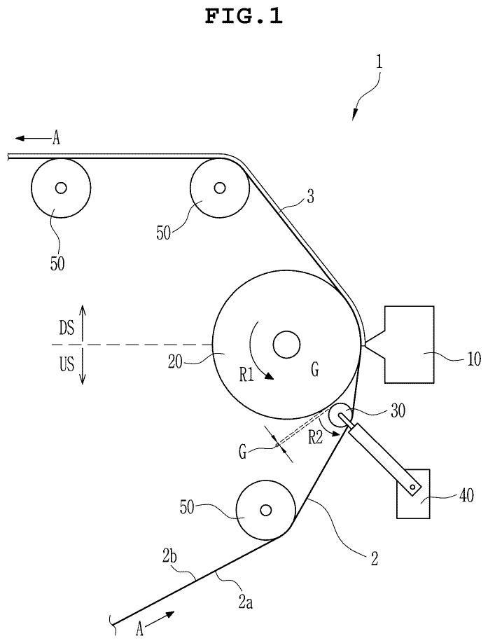

FIG. 1 is a view illustrating an electrode coating apparatus 1 according to an embodiment.

The electrode coating apparatus 1 is an apparatus to manufacture electrodes and may be an apparatus to manufacture electrodes by coating a slurry 3 on a base substrate 2, and the slurry 3 may include an electrode active material.

According to an embodiment, the electrode coating apparatus 1 may include a coating roller 20 brought into contact with the base substrate 2 and configured to rotate for the base substrate 2 to move, a slot die coater 10 configured to supply the slurry 3 on a surface 2a of the base substrate 2 in contact with the coating roller 20, and a blocking roller 30, at an upper stream US where the base substrate 2 moves toward the coating roller 20, located between the coating roller 20 and the base substrate 2 and configured to block air flowing between the coating roller 20 and the base substrate 2.

The electrode coating apparatus 1 may apply the slurry 3 on the base substrate 2.

The base substrate 2 may include a current collector in an electrode for a secondary battery. The base substrate 2 may include the first surface 2a on which the slurry 3 is applied, and a second surface 2b opposite to the first surface 2a.

The base substrate 2 may be a thin film including a metal such as copper (Cu), aluminum (Al), stainless steel, etc. or an alloy thereof. The slurry 3 may be a mixture including an active material, a solvent, a binder, etc. The slurry 3 may be applied to the base substrate 2 by the slot die coater 10. The active material may be a negative active material or a positive active material. The negative active material may include carbonaceous material such as graphite, lithium alloy, silicon, tin, etc. The positive active material may include lithium cobalt oxide, lithium manganese oxide, lithium nickel oxide, lithium iron phosphate oxide, etc.

The coating roller 20 may have a cylindrical body overall. The coating roller 20 may rotate by being brought into contact with the second surface 2b of the base substrate 2. The coating roller 20 may transfer the base substrate 2 when rotating. The base substrate 2 may move in a rotation direction R1 of the coating roller 20 (arrow A). The coating roller 20 may support the second surface 2b of the base substrate 2 when the slot die coater 10 discharges the slurry 3 on the first surface 2a of the base substrate 2.

The slot die coater 10 may be a device configured to apply the slurry 3 to the base substrate 2. The slot die coater 10 may include an outlet through which the slurry 3 is discharged. The slot die coater 10 may be arranged such that the outlet faces the first surface 2a of the base substrate 2 supported by the coating roller 20. The outlet may be shaped in a slot that is overall thin and long. The slot die coater 10 may be arranged such that the outlet is parallel to the coating roller 20.

The base substrate 2 may be transferred to pass in front of the outlet of the slot die coater 10. The base substrate 2 may be transferred by one or more transfer rollers 50. The base substrate 2 may be supplied into an unwinder in a roll form of winding around a bobbin and may be supplied to the electrode coating apparatus 1 as the unwinder unwinds the base substrate 2. The base substrate 2 may move from an upstream US toward a downstream DS with the coating roller 20 as the center (arrow A). In the upper stream US, the base substrate 2 moves toward the coating roller 20, and in the downstream DS, a distance of the base substrate 2 from the coating roller 20 increases. The blocking roller 30 may be located in the upper stream US. The blocking roller 30 may be located between the base substrate 2 and the coating roller 20 in the upper stream US.

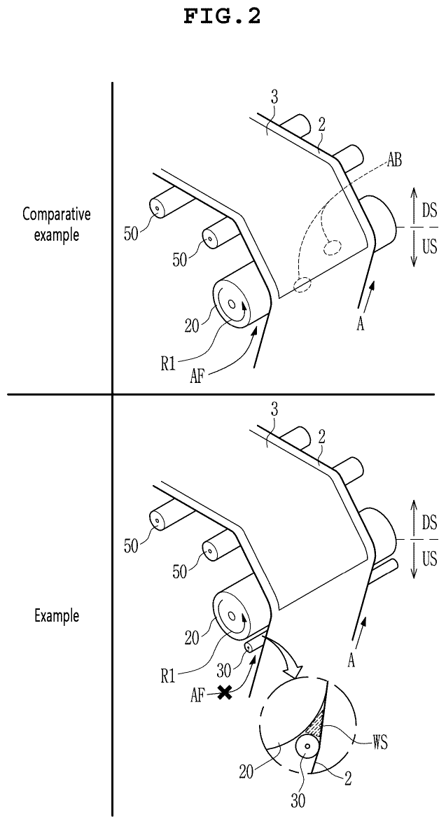

The blocking roller 30 may block air from entering into the coating roller 20 and the second surface 2b of the base substrate 2. The blocking roller 30 may be a roller that is overall cylindrical. The blocking roller 30 may be located between the coating roller 20 and the second surface 2b of the base substrate 2 and block an airflow entering between the coating roller 20 and the second surface 2b of the base substrate 2 (referring to AF in FIG. 2).

The blocking roller 30 may rotate in contact with the base substrate 2. The blocking roller 30 may be spaced apart from the coating roller 20 not to be in contact with the coating roller 20. The coating roller 20 may rotate in a direction of R1, and the blocking roller 30 may rotate in a direction of R2. Since both the coating roller 20 and the blocking roller 30 are in contact with the second surface 2b of the base substrate 2, the coating roller 20 and the blocking roller 30 may rotate in the same direction. Therefore, the coating roller 20 and the blocking roller 30 may be spaced apart from each other to prevent contact therebetween. A distance between the coating roller 20 and the blocking roller 30 may be determined to be as small as possible.

According to an embodiment, the electrode coating apparatus 1 may include a position driver 40 adjusting a position of the blocking roller 30 from the coating roller 20.

The position driver 40 may adjust a position of the blocking roller 30 to be close to or far from the coating roller 20. The position driver 40 may move the blocking roller 30 in a horizontal or vertical direction on the drawing. The position driver 40 may use a cylinder, motor, gear, and other known structures to change the position of the blocking roller 30 and fix the blocking roller 30 at a set position. The position driver 40 may move the blocking roller 30 to a position where the blocking roller 30 is not in contact with the coating roller 20 and a wedge-shaped space among the coating roller 20, the blocking roller 30, and the base substrate 2 (referring to WS in FIG. 2) is minimized. As the wedge-shaped space (referring to WS in FIG. 2) is minimized, an airflow flowing between the coating roller 20 and the base substrate 2 (referring to AF in FIG. 2) may be blocked.

FIG. 2 is a view illustrating an airflow AF in the electrode coating apparatus 1 according to an embodiment. FIG. 2 illustrates an airflow AF in a comparative example and a flow of air AF in an example.

Referring to FIG. 2, the specific example will be described additionally. The example does not limit the patent right of the present disclosure, and those skilled in the art will appreciate that various modifications, additions, and substitutions are possible, within the scope and spirit of the present disclosure, and these changes and modifications are naturally included in the appended claims.

The comparative example does not include the blocking roller 30. In the comparative example, an airflow AF may exist between the coating roller 20 and the base substrate 2. The airflow AF may exist in the upper stream US where the base substrate 2 moves to the coating roller 20. The airflow AF may be generated when air rubbed against the second surface 2b of the base substrate 2 moves together in a moving direction of the base substrate 2 (arrow A). The airflow AF may be generated when air rubbed against a surface of the coating roller 20 moves along with the rotation direction RI of the coating roller 20. The airflow AF may be stronger as a moving speed of the base substrate 2 is fast and a rotation speed of the coating roller 20 is fast. Depending on the airflow AF, air may enter between the coating roller 20 and the base substrate 2 and an air bubble AB where air is entrapped between the coating roller 20 and the base substrate 2 may be formed. When the air bubble AB is generated, a surface of the base substrate 2 is uneven, and the slurry 3 discharged from the slot die coater 10 may be unevenly discharged. Accordingly, there may be a defect in which wrinkles may occur on the base substrate 2 to which the slurry 3 is applied.

The example includes the blocking roller 30. In the example, in the upper stream US of the base substrate 2, the blocking roller 30 may be located between the coating roller 20 and the base substrate 2. The blocking roller 30 may block the airflow AF generated between the coating roller 20 and the base substrate 2.

In an area from the transfer roller 50 to the blocking roller 30, the airflow AF generated when air rubbed against the second surface 2b of the base substrate 2 moves together in a moving direction of the base substrate 2 (arrow A) may be blocked by hitting the blocking roller 30 that is in contact with the second surface 2b of the base substrate 2. Since a distance between the point where the base substrate 2 is brought into contact with the blocking roller 30 and the point where the base substrate 2 is brought into contact with the coating roller 20 is short, it is difficult to form air rubbed against the second surface 2b of the base substrate 2 passing through the blocking roller 30 into the airflow AF.

It is difficult for the airflow AF that moves while being rubbed against the surface of the coating roller 20 due to the rotation of the coating roller 20 to pass through a gap G between the coating roller 20 and the blocking roller 30. This is because the distance of the gap G between the coating roller 20 and the blocking roller 30 is short and it is difficult to form the airflow AF. Air moving with rotation of the coating roller 20 and air moving with rotation of the blocking roller 30 collide with each other in opposite direction in the gap between the coating roller 20 and the blocking roller 30, so it is difficult for the airflow AF caused by rotation of the coating roller 20 to pass through the blocking roller 30.

In summary, since the blocking roller 30 is located between the coating roller 20 and the second surface 2b of the base substrate 2 and rotates in contact with the second surface 2b of the base substrate 2, the blocking roller 30 may block the airflow AF formed along movement of the base substrate 2 directly, and the airflow AF formed along rotation of the coating roller 20 may be canceled out by air caused by rotation of the blocking roller 30. Therefore, the blocking roller 30 may block the airflow AF entering between the coating roller 20 and the base substrate 2.

The blocking roller 30 may have a smaller diameter than the diameter of the transfer roller 50 transferring the base substrate 2. The blocking roller 30 may have a much smaller diameter than the diameter of the coating roller 20. As the diameter of the blocking roller 30 is reduced, a wedge-shaped space WS between the coating roller 20 and the second surface 2b of the base substrate 2 may be minimized. When the size of the wedge-shaped space WS is minimized, the total amount of movable air in the wedge-shaped space WS is minimized, so the possibility of air flowing between the coating roller 20 and the base substrate 2 may be minimized. For example, the blocking roller 30 may have a diameter ranging from 40 mm to 120 mm, but is not limited thereto. A diameter of the blocking roller 30 may be determined in consideration of the size of the coating roller 20, the rotation speed of the coating roller 20, and the transfer speed of the base substrate 2.

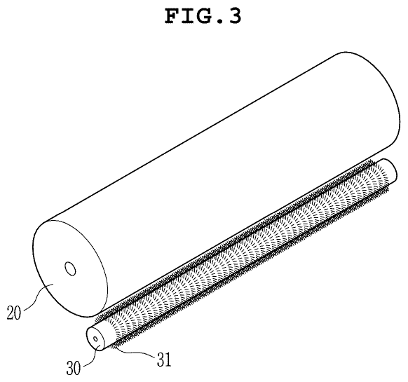

FIG. 3 is a view illustrating the blocking roller 30 on which a brush 31 is formed according to an embodiment.

The blocking roller 30 may include a brush 31 formed on an outer circumferential surface. The brush 31 may be formed into a form in which the brush reaches radially on the outer circumferential surface of the blocking roller 30. Bristles of the brush 31 may be arranged with high density, have short lengths, and made of a soft material. The bristles of the brush 31 are made of a soft material, so it is possible to prevent the base substrate 2 from being damaged when being brought into contact with the second surface 2b of the base substrate 2. The bristles of the brush 31 are arranged with high density and may block the airflow AF flowing into the gap between the coating roller 20 and the blocking roller 30. The bristles of the brush 31 may have short lengths and be formed not to be brought into contact with the blocking roller 30.

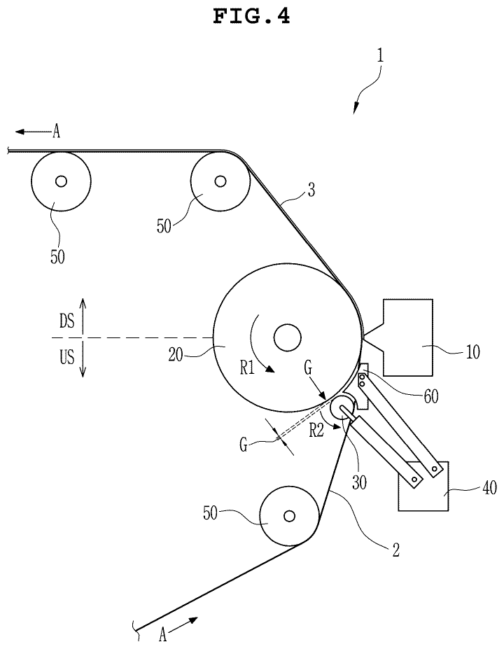

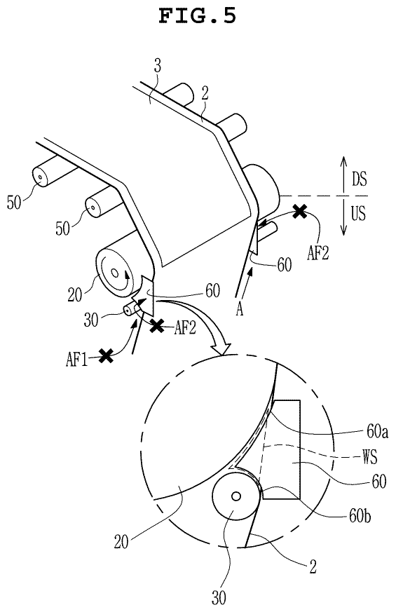

FIG. 4 is a view illustrating the electrode coating apparatus 1 including a blocking plate 60 according to an embodiment. FIG. 5 is a view illustrating an airflow AF1, AF2 in the electrode coating apparatus 1 including the blocking plate 60 according to an embodiment.

According to an embodiment, the electrode coating apparatus 1 may include the blocking plate 60, and the blocking plate 60 may prevent air from flowing through the wedge-shaped space (referring to WS in FIG. 2 and WS in FIG. 5) formed among the blocking roller 30, the coating roller 20, and the base substrate 2. The blocking plate 60 may be located at opposite portions of the wedge-shaped space WS formed by the base substrate 2, the coating roller 20, and the blocking roller 30 in the upper stream US in which the base substrate 2 moves toward the coating roller 20.

When the blocking roller 30 is located between the coating roller 20 and the base substrate 2, the wedge-shaped space WS is open at the opposite sides in the width direction of the base substrate 2. In addition to the first airflow AF1 blocked by the blocking roller 30, there may be a second airflow AF2 in which air flows into the opposite sides of the wedge-shaped space WS.

The first airflow AF1 generated by rotation of the coating roller 20 and movement of the base substrate 2 may be blocked by the blocking roller 30. However, there is a possibility that the second airflow AF2 is generated through the opposite sides of the wedge-shaped space WS. The blocking plate 60 blocks the opposite sides of the wedge-shaped space WS, thereby preventing the second airflow AF2.

The blocking plate 60 may be made of metal or synthetic resin material. The blocking plate 60 may be formed into a plate thick enough to block the second airflow AF2. The blocking plate 60 may be formed at each side in the width direction of the base substrate 2.

the blocking plate 60 blocks the opposite sides of wedge-shaped space WS surrounded by the coating roller 20, the base substrate 2, and the blocking roller 30, so a space for air entering the inside space of the wedge-shaped space WS may be minimized. It is difficult for air to enter the wedge-shaped space WS, so the possibility of air flowing between the coating roller 20 and the base substrate 2 may be reduced.

The blocking plate 60 may have an entirely wedged shape. The blocking plate 60 may be shaped, at a first portion 60a of the wedge shape, into a curved line corresponding to a curved surface of the coating roller 20, and, at a second portion 60b, into a curved line corresponding to a curved surface of the blocking roller 30. The first portion of the blocking plate 60 may be spaced apart from the coating roller 20 and arranged such that the distance between the coating roller 20 and the blocking plate 60 is short. The second portion of the blocking plate 60 may be spaced apart from the blocking roller 30 and arranged such that the distance between the blocking roller 30 and the blocking plate 60 is short. The blocking plate 60 may be spaced apart from the base substrate 2 and arranged such that a distance between the base substrate 2 and the blocking plate 60 is short.

The blocking roller 30 and the blocking plate 60 may block an entry path of air flowing between the coating roller 20 and the base substrate 2, so the possibility of air flowing between the coating roller 20 and the base substrate 2 may be minimized. Even when the rotation speed of the coating roller 20 and the moving speed of the base substrate 2 are fast, the blocking roller 30 and the blocking plate 60 may block the first airflow AF1 and the second airflow AF2 and air flowing between the coating roller 20 and the base substrate 2 may be minimized.

According to an embodiment, the electrode coating apparatus 1 may include the position driver 40, and the position driver 40 may adjust a position of the blocking roller 30 with respect to the coating roller 20 and adjust a position of the blocking plate 60 for the blocking plate 60 to block the wedge-shaped space WS. The position driver 40 may adjust a position of the blocking roller 30 and a position of the blocking plate 60 separately. The position driver 40 may locate the blocking roller 30 first, and based on the position of the blocking roller 30, may adjust a position of the blocking plate 60. The position driver 40 for moving and fixing positions of the blocking roller 30 and the blocking plate 60 may be known structures such as a cylinder, a motor, a gear, etc.

As described above, according to an embodiment, air flowing between the coating roller 20 and the base substrate 2 can be minimized to improve the coating uniformity of the electrode active material and to prevent defects of wrinkles occurring in an electrode. In addition, according to an embodiment, even in the environment in which the rotation speed of the coating roller 20 is fast, air flowing between the coating roller 20 and the base substrate 2 can be minimized.

Hereinabove, the present disclosure has been described in detail with the specific embodiment. Although a preferred embodiment of the present invention has been described for illustrative purposes, various modifications, additions, and substitutions may be included, without departing from the scope and spirit of the present disclosure.

1. An electrode coating apparatus comprising:
a coating roller brought into contact with a base substrate and configured to rotate for the base substrate to be moved;
a slot die coater configured to supply slurry on one surface of the base substrate in contact with the coating roller; and
a blocking roller, in an upper stream in which the base substrate is moved toward the coating roller, located between the coating roller and the base substrate and configured to block air flowing between the coating roller and the base substrate.

2. The electrode coating apparatus of claim 1, wherein the blocking roller has a diameter smaller than a diameter of a transfer roller transferring the base substrate.

3. The electrode coating apparatus of claim 2, wherein the blocking roller has a diameter ranging from 40 mm to 120 mm.

4. The electrode coating apparatus of claim 1, wherein the blocking roller comprises a brush formed on an external circumferential surface.

5. The electrode coating apparatus of claim 1, further comprising:
a position driver configured to adjust a location of the blocking roller with respect to the coating roller.

6. The electrode coating apparatus of claim 5, wherein the position driver is configured to locate the blocking roller to a position where a wedge-shaped space among the coating roller, the blocking roller, and the base substrate is minimized, without the blocking roller in contact with the coating roller.

7. The electrode coating apparatus of claim 1, further comprising:
a blocking plate configured to block air from flowing through a wedge-shaped space formed among the blocking roller, the coating roller, and the base substrate.

8. The electrode coating apparatus of claim 7, wherein the blocking plate is formed in a wedged shape, and a first portion of the wedged shape is formed into a curved line corresponding to a curved surface of the coating roller, and a second portion thereof is formed into a curved line corresponding to a curved surface of the blocking roller.

9. The electrode coating apparatus of claim 7, further comprising:
a position driver configured to adjust a position of the blocking roller with respect to the coating roller and to adjust a position of the blocking plate so that the blocking plate blocks a wedge-shaped space.
